(19) United States
(12) Patent Application Publication
(10) Pub. No.: US 2002/0168303 A1
(43) Pub. Date: Nov. 14, 2002

(54) Metal case of exhaust device and method of producing same

(75) Inventor: Yasuhiro Nogami, Gunma (JP)

Correspondence Address: FOLEY AND LARDNER, SUITE 500, 3000 K STREET NW, WASHINGTON, DC, 20007, US

(73) Assignee: CALSONIC KANSEI CORPORATION

(21) Appl. No.: 10/128,522

(22) Filed: Apr. 24, 2002

(30) Foreign Application Priority Data
Apr. 24, 2001 (JP) 2001-125921
Mar. 27, 2002 (JP) 2002-088744

(51) Int. Cl. B01D 53/34; F01N 3/28

(52) U.S. Cl. 422/177; 422/171; 422/180

(57) ABSTRACT

In order to simplify and ensure the bending process of an inlet or outlet pipe portion of a metal case, there is provided accordion folds between the pipe portion and a major portion of the case. When, for bending the pipe portion, a certain force is applied to the pipe portion, the accordion folds are subjected to a plastic deformation thereby inclining the pipe portion relative to a major portion of the case.

### BACKGROUND OF THE INVENTION

1. Field of the Invention

The present invention relates in general to devices of an exhaust system of an automotive engine, and more particularly to metal cases for housing elements of such exhaust devices. More specifically, the present invention is concerned with the metal case of such exhaust devices and a method for producing the same.

2. Description of the Prior Art

In order to clarify the task of the present invention, a metal case 10 of a catalytic converter of an automotive engine, which has been widely employed, will be briefly described with reference to FIG. 6 of the accompanying drawings.

As shown in the drawing, the metal case 10 generally comprises an enlarged round center portion 10a, a tapered inlet portion 10b connected to an upstream end of the center portion 10a and a tapered outlet potion 10c connected to a downstream end of the center portion 10a. The enlarged round center portion 10a has a catalyst carrier installed therein. The inlet portion 10b has a diametrically reduced inlet pipe part 10b′ that is to be connected to an upstream exhaust pipe leading to an exhaust manifold (not shown) of the engine, and the outlet potion 10c has a diametrically reduced outlet pipe part 10c′ connected to a downstream exhaust pipe leading to a muffler (not shown).

Usually, the metal case 10 having the above-mentioned style is produced by a drawing process. That is, first, a cylindrical hollow body having the same diameter as the round center portion 10a is provided. Then, the hollow body is put on a suitable lathe and axially opposed portions of the hollow body are each tapered by pressing a pressing roller (not shown) thereto revolving the entire of the hollow body. The process is advantageous because of simple, low cost and easy production of the metal case 10.

However, as is seen from the drawing, due to a limited space available under a vehicle floor to which the catalytic converter is mounted, some of the metal cases 10 of the catalytic converter are compelled to have the inlet pipe part 10b′ inclined relative to a longitudinal axis 12 of the converter by a given angle “θ”. Thus, this type metal case 10 can not be produced by an ordinary drawing process in which the pressing roller moves in the direction of the arrow “z” and the hollow body (viz., work) moves in the direction of the arrow “y”.

Accordingly, hitherto, an additional step has been employed. That is, after the case 10 is produced by using an ordinary drawing method, the inlet pipe part 10b′ is bent by using a bending device. Furthermore, as is disclosed by Japanese Patent 2957154, a unique drawing process has been used in which after the cylindrical hollow body (viz., work) is set on a lathe with a certain inclination relative to the longitudinal axis 12, a pressing roller is pressed against the inlet pipe part 10b′ revolving about the longitudinal axis 12.

However, the above-mentioned methods for providing the metal case 10 with the inclined inlet pipe part 10b′ need a complicated, skilled and time-consumed technique, which has brought about a high cost production of the case. Furthermore, these methods tend to apply a marked stress to limited portions of the work where the pressing force of the pressing device or pressing roller is directly applied. Thus, if the stress is excessive, the portions tend to produce undesirable cracks.

### SUMMARY OF THE INVENTION

It is therefore an object of the present invention to provide a method of producing a metal case of an exhaust device, which is free of the above-mentioned drawbacks.

According to a first aspect of the present invention, there is provided a metal case of an exhaust device, which comprises an enlarged round center portion having a longitudinal axis; first and second tapered portions respectively connected at diametrically larger ends thereof to axially opposed ends of the enlarged round center portion; first and second pipe portions respectively connected to diametrically smaller ends of the first and second tapered portions respectively; and accordion folds defined by and between the first tapered portion and the first pipe portion, wherein the first pipe portion is bent relative to the longitudinal axis as a result of plastic deformation of the accordion folds.

According to a second aspect of the present invention, there is provided a method of producing a metal case of an exhaust device, which comprises the steps of (a) preparing a round hollow body of metal; (b) subjecting the round hollow body to a drawing process to provide a first semi-finished aligned product which comprises an enlarged round center portion, first and second tapered portions respectively connected at diametrically larger ends thereof to axially opposed ends of the enlarged round center portion, and first and second pipe portions respectively connected to diametrically smaller ends of the first and second tapered portions respectively; (c) subjecting the first semi-finished aligned product to a folds-producing process to produce and define accordion folds between the first tapered portion and the first pipe portion thereby to provide a second semi-finished aligned product; (d) holding a major portion of the second semi-finished aligned product to a fixed member; and (e) applying a given force to the first and second pipe portion in a manner to induce a plastic deformation of the accordion folds thereby to bend the pipe portion relative to a longitudinal axis of the major portion of said second semi-finished aligned product.

According to a third aspect of the present invention, there is provided a metal case of an exhaust device, which comprises an enlarged round center portion having a longitudinal axis; first and second tapered portions respectively connected at diametrically larger ends thereof to axially opposed ends of the enlarged round center portion; first and second pipe portions respectively connected to diametrically smaller ends of the first and second tapered portions respectively; first accordion folds defined by and between the first tapered portion and the first pipe portion; and second accordion folds defined by and between the second tapered portion and the second pipe portion, wherein at least one of the first and second pipe portions is bent relative to the longitudinal axis as a result of plastic deformation of corresponding one of the first and second accordion folds.

According to a fourth aspect of the present invention, there is provided a method of producing a metal case of an exhaust device, which comprises the steps of preparing a round hollow body of metal; subjecting the round hollow body to a drawing process to provide a first semi-finished aligned product which comprises an enlarged round center portion, first and second tapered portions respectively connected at diametrically larger ends thereof to axially opposed ends of the enlarged round center portion, and first and second pipe portions respectively connected to diametrically smaller ends of the first and second tapered portions respectively; subjecting the first semi-finished aligned product to a folds-producing process to produce and define first accordion folds between the first tapered portion and the first pipe portion and second accordion folds between the second tapered portion and the second pipe portion thereby to provide a second semi-finished aligned product; holding a major portion of the second semi-finished aligned product to a fixed member; and applying a given force to at least one of the first and second pipe portions in a manner to induce a plastic deformation of corresponding one of the first and second accordion folds thereby to bend the pipe portion relative to a longitudinal axis of the major portion of the second semi-finished aligned product.

According to a fifth aspect of the present invention, there is provided a catalytic converter which comprises a metal case including an enlarged round center portion having a longitudinal axis, first and second tapered portions respectively connected at diametrically larger ends thereof to axially opposed ends of the enlarged round center portion, first and second pipe portions respectively connected to diametrically smaller ends of the first and second tapered portions respectively, first accordion folds defined by and between the first tapered portion and the first pipe portion, and second accordion folds defined by and between the second tapered portion and the second pipe portion, at least one of the first and second pipe portions being bent relative to the longitudinal axis as a result of plastic deformation of corresponding one of the first and second accordion folds; and a catalyst carrier tightly installed in the enlarged round center portion of the metal case.

According to a sixth aspect of the present invention, there is provided a method of producing a catalytic converter, which comprises the steps of preparing a round hollow body of metal; inserting a catalyst carrier into the round hollow body; subjecting the round hollow body to a drawing process to provide a first semi-finished aligned product which comprises an enlarged round center portion in which the catalyst carrier is installed, first and second tapered portions respectively connected at diametrically larger ends thereof to axially opposed ends of the enlarged round center portion, and first and second pipe portions respectively connected to diametrically smaller ends of the first and second tapered portions respectively; subjecting the first semi-finished aligned product to a folds-producing process to produce and define first accordion folds between the first tapered portion and the first pipe portion and second accordion folds between the second tapered portion and the second pipe portion thereby to provide a second semi-finished aligned product; holding a major portion of the second semi-finished aligned product to a fixed member; and applying a given force to at least one of the first and second pipe portions in a manner to induce a plastic deformation of corresponding one of the first and second accordion folds thereby to bend the pipe portion relative to a longitudinal axis of the major portion of the second semi-finished aligned product.

### BRIEF DESCRIPTION OF THE DRAWINGS

Other objects and advantages of the present invention will become apparent from the following description when taken in conjunction with the accompanying drawings, in which:

FIG. 1 is a side view of a metal case of exhaust device, which is a first embodiment of the present invention;

FIG. 2 is a view similar to FIG. 1, but showing a second embodiment of the present invention;

FIGS. 3A to 3D are views showing a method of producing the metal case of the first embodiment;

FIG. 4 is an enlarged sectional view of a part of the metal case of the first embodiment, depicting a step of bending an inlet pipe portion of the case;

FIG. 5 is a sectional view of a part of the metal case of the first embodiment, depicting another step of bending the inlet pipe portion of the case; and

FIG. 6 is a view similar to FIG. 1, but showing a conventional metal case of exhaust device.

### DETAILED DESCRIPTION OF THE EMBODIMENTS

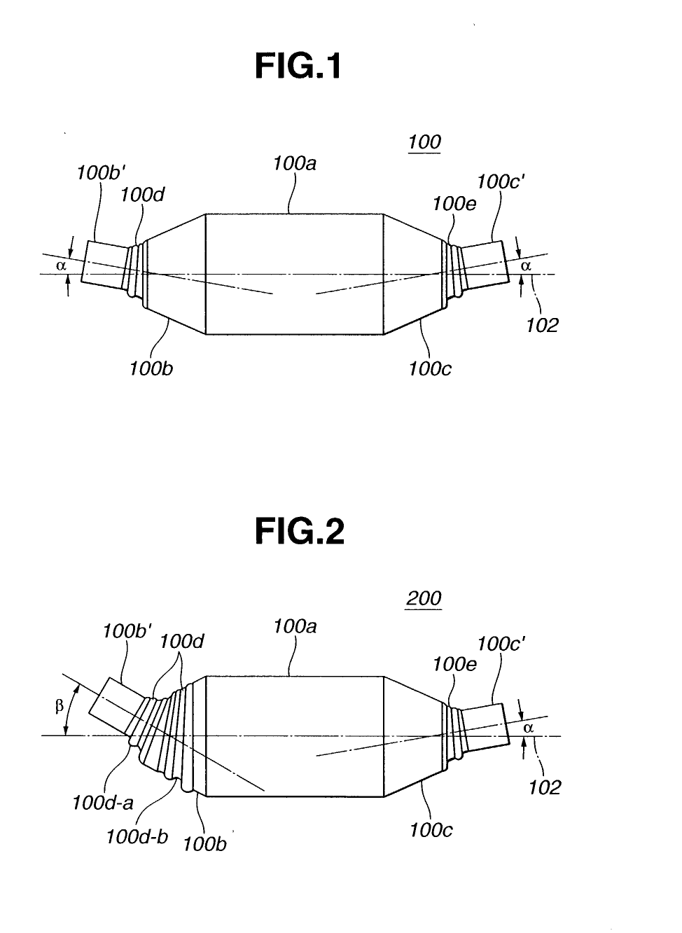

Referring to FIG. 1, there is shown a metal case 100 of a catalytic converter, which is a first embodiment of the present invention.

As shown in the drawing, the metal case 100 comprises an enlarged round center portion 100a that contains therein a catalyst carrier, a tapered inlet portion 100b connected to an upstream end of the center portion 100a and a tapered outlet portion 100c connected to a downstream end of the center portion 100a. The tapered inlet portion 100b has a diametrically reduced inlet pipe portion 100b′ that is to be connected to an upstream exhaust pipe leading to an exhaust manifold (not shown) of the engine, and the tapered outlet portion 100c has a diametrically reduced outlet pipe portion 100c′ that is to be connected to a downstream exhaust pipe leading to a muffler (not shown).

Between the tapered inlet portion 100b and the inlet pipe portion 100b′, there are integrally formed accordion folds or bellows 100d, and similar to this, between the tapered outlet portion 100c and the outlet pipe portion 100c′, there are integrally formed accordion folds or bellows 100e. Due to provision of the accordion folds 100d and 100e which have been plastically deformed, the inlet and outlet pipe portions 100b′ and 100c′ are inclined relative to a longitudinal axis 102 of the metal case 100 by a given angle “α”. As is seen from the drawing, the accordion folds 100d and 100e are identical in shape, including the same number of pleats or folds.

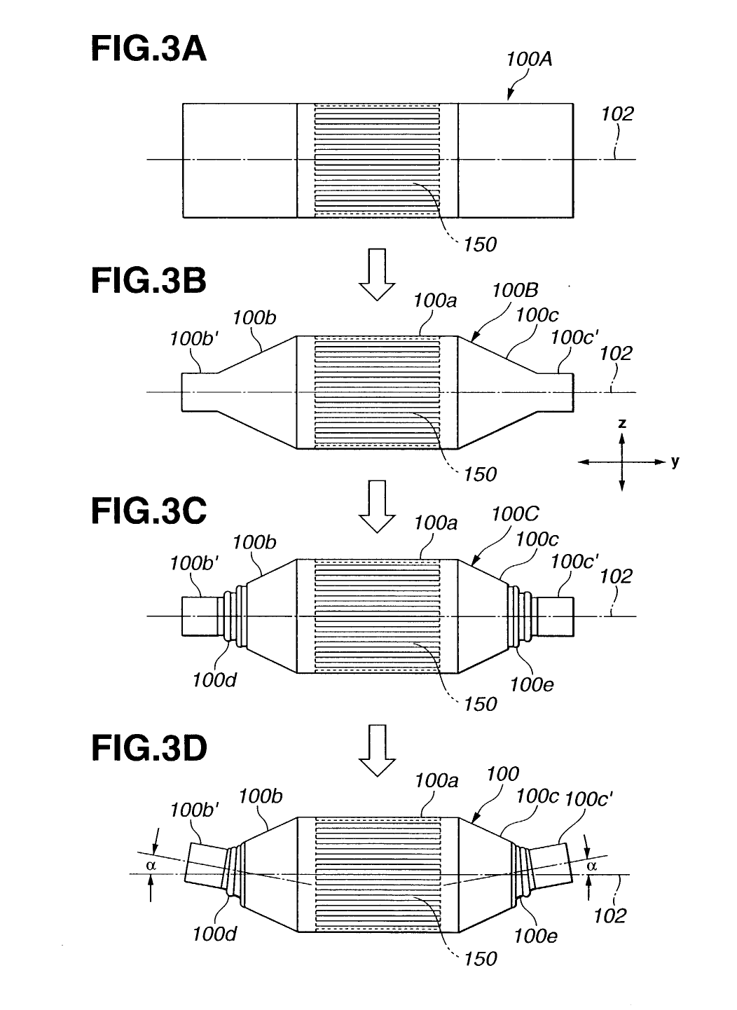

In the following, method of producing the metal case 100 will be described with reference to FIGS. 3A to 3D.

First, as is seen from FIG. 3A, a cylindrical hollow body 100A of stainless steel, copper or the like is prepared. Then, a catalyst carrier 150 is inserted into a center position of the cylindrical hollow body 100A.

Then, the cylindrical hollow body 100A is set on a lathe (not shown), and as is seen from FIG. 3B, axially opposed portions of the cylindrical hollow body 100A are each drawn by pressing a pressing roller (not shown) thereto revolving the entire of the cylindrical hollow body 100A about a longitudinal axis 102. That is, during this process, the pressing roller moves in the direction of the arrow “z” and the cylindrical hollow body 100A (viz., work) moves in the direction of the arrow “y”. With this drawing step, tapered inlet and outlet portions 100b and 100c protruding from an enlarged center portion 100a are produced. By continuing the drawing process by the pressing roller, inlet and outlet pipe portions 100b′ and 100c′ are also produced. With these steps, a first semi-finished aligned product 100B is prepared, which comprises the enlarged center portion 100a, the tapered inlet and outlet portions 100b and 100c and the diametrically reduced inlet and outlet pipe portions 100b′ and 100c′, which are all aligned along the longitudinal axis 102.

Then, as is seen from FIG. 3C, the pressing roller is applied to a junction portion between the tapered inlet or outlet portion 100b or 100c and the inlet or outlet pipe portion 100b′ or 100c′, and pressed thereto strongly and lightly periodically, revolving the first semi-finished product 100B about the longitudinal axis 102 while moving the same along the longitudinal axis 102. With this, accordion folds 100d and 100e aligned with the longitudinal axis 102 are produced. Thus, a second semi-finished aligned product 100C is produced as is shown in FIG. 3C. If this folds-producing process is actually carried out while the first semi-finished aligned product 100B keeps a certain higher temperature, the process is much easily and assuredly carried out because a work-hardening can be avoided.

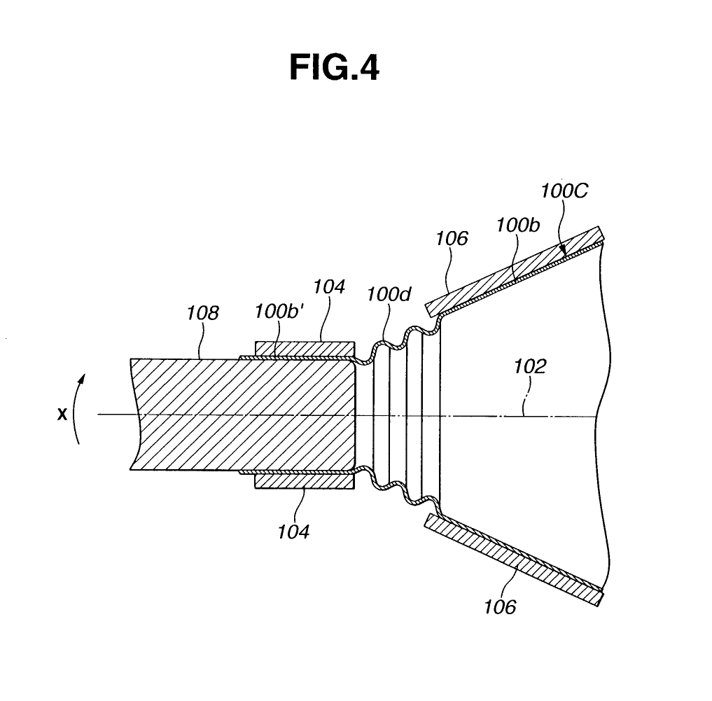

Then, the second semi-finished product 100C is brought to a hydraulically powered bending device for bending the inlet and outlet pipe portions 100b′ and 100c relative to the longitudinal axis 102 by the given angle “α”. That is, as is seen from FIG. 4, the inlet and outlet pipe portions 100b′ and 100c′ are respectively held by first clamps 104 (only one is shown) and the tapered inlet and outlet portions 100b and 100c are respectively held by second clamps 106 (only one is show). Then, cylindrical bars 108 (only one is shown) are respectively and intimately put into the inlet and outlet pipe portions 100b′ and 100c′. Then, both the cylindrical bars 108 and the first clamps 104 are pulled in the direction of the arrow “x” with the aid of hydraulic power. With this, as shown in FIG. 3D, the accordion folds 100d and 100e are plastically deformed inclining the inlet and outlet pipe portions 100b′ and 100c′ relative to the longitudinal axis 102 by the angle “α”. With these steps, the metal case 100 is produced.

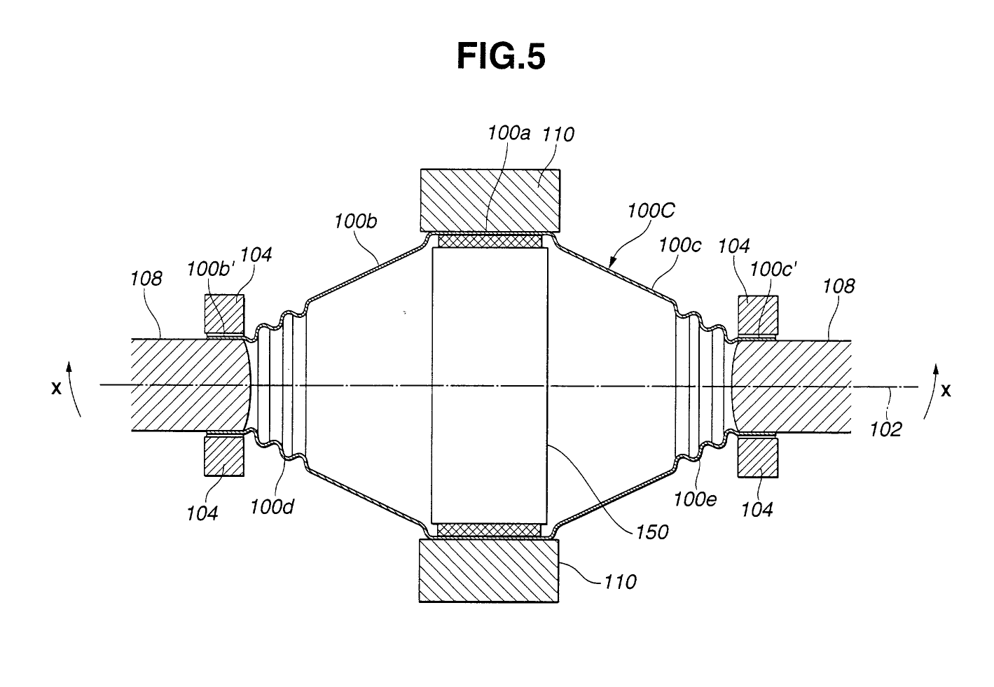

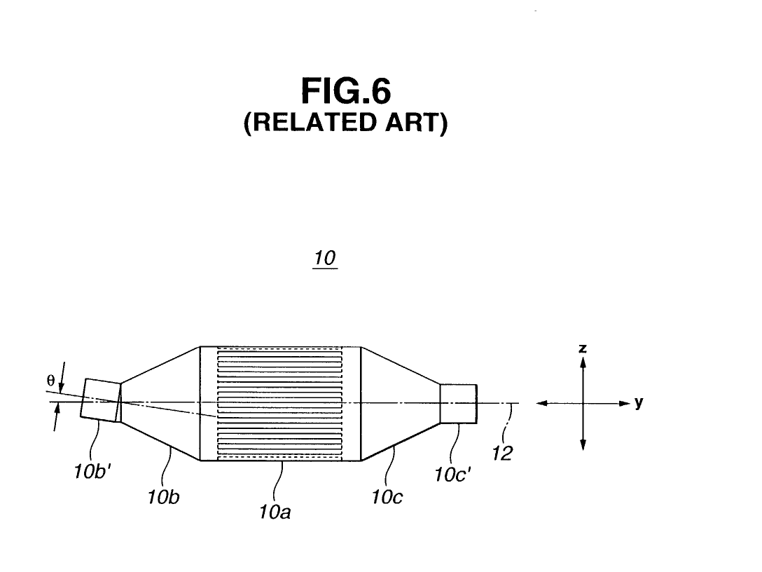

If desired, as is shown in FIG. 5, in place of the above-mentioned second clamps 106 by which the tapered inlet and outlet portions 100b and 100c are held, a simpler clamp 110 may be used which holds the enlarged center portion 100a of the second semi-finished product 100C. Also in this case, the first clamps 104 holding the inlet and outlet pipe portions 100b′ and 100c′ and the cylindrical bars 108 intimately put in the inlet and outlet pipe portions 100b′ and 100c′ are employed, and bending of the inlet and outlet pipe portions 100b′ and 100c′ is carried out by pulling both the cylindrical bars 108 and the first clamps 104 in the direction of the arrow “x”.

As is described hereinabove, due to provision of the accordion folds 100d and 100e which show a certain flexibility and plasticity, the bending of the inlet and outlet pipe portions 100b′ and 100c′ is readily and assuredly made without inducing a possibility of producing undesirable cracks. That is, due to the nature of the accordion folds 100d and 100e, the bending of the inlet and outlet pipe portions 100b′ and 100c′ is carried out by shrinking or expanding certain portions of the accordion folds 100d and 100e without making a reduction in plate thickness. That is, as is seen from FIG. 4, under bending of the inlet pipe portion 100b′ in the direction of the arrow “x”, upper portions of the accordion folds 100d are subjected to shrinkage and lower portions of the same are subjected to expansion. However, these shrinking and expanding movements of the accordion folds 100d do not induce reduction in thickness of the plate material of the folds 100d. In other words, the mechanical strength of the accordion folds 100d is kept unchanged even when the inlet pipe portion 100b′ is bent.

Referring back to FIG. 2, there is shown a case 200 of a catalytic converter, which is a second embodiment of the present invention.

In this second embodiment 200, the number of pleats of the accordion folds 100d is greater than that of the accordion folds 100e. Furthermore, the accordion folds 100d largely enter the tapered inlet portion 100b. More specifically, the accordion folds 100d comprise first and second groups of accordion folds 100d-a and 100d-b which are separated at their mating part. Thus, the inlet pipe portion 100b′ can be much largely inclined (viz., angle “β”) relative to the longitudinal axis 102 as compared with of the outlet pipe portion 100c′ (viz., angle “α”). Due to provision of the first and second groups of accordion folds 100d-a and 100d-b, a so-called two step bending is achieved for the inlet pipe portion 100b′. That is, a plastic deformation degree of the first group of accordion folds 100d-a is larger than that of the second group of accordion folds 100d-b.

As is described hereinabove, in the present invention, the cylindrical hollow body 100A is subjected to a drawing process to provide the first semi-finished aligned product 100B as shown in FIG. 3B. Then, the first semi-finished aligned product 100B is subjected to a folds-producing process to provide the second semi-finished aligned product 100C as shown in FIG. 3C. Then, the second semi-finished aligned product 100C is held by clamping means including the second clamps 106 or the third clamp 110, and bending of the inlet and outlet pipe portions 100b′ and 100c′ of the second semi-finished product 100C is carried out with the aid of the first clamps 104 and the cylindrical bars 108. Thus, bending of the inlet and outlet pipe portions 100b′ and 100c′ is readily and assuredly carried out without sacrificing mechanical strength of a part of the case 100 where the bending is actually made.

Furthermore, in the present invention, for bending the inlet or outlet pipe portion 100b′ or 100c′, the major portion of the second semi-finished product 100C is tightly held by clamping means and both the first clamp 104 holding the inlet or outlet pipe portion 100b′ or 100c′ and the cylindrical bar 108 intimately put in the inlet or outlet pipe portion 100b′ or 100c′ are pulled in the given direction “x”. Thus, the inlet or outlet pipe portion 100b′ or 100c′ can be accurately bent by a desired angle.

If desired, for bending the inlet or outlet pipe portion 100b′ or 100c′ relative to the longitudinal axis 102, the major portion of the second semi-finished product 100C may be pulled or pushed in a given direction keeping both the first clamp 104 and the cylindrical bar 108 at their fixed positions.

In the above-mentioned first and second embodiments, each metal case 100 or 200 has two accordion folds 100d and 100e at axially opposed portions thereof. However, if desired, the case 100 or 200 may have only one accordion folds at one axially end portion. Of course, in this case, the inlet or outlet pipe portion extending from the accordion folds is subjected to the inclination due to plastic deformation of the accordion folds.

The entire contents of Japanese Patent Application 2001-125921 filed Apr. 24, 2001, and Japanese Patent Application 2002-088744 filed Mar. 27, 2002, are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A metal case of an exhaust device, comprising:
an enlarged round center portion having a longitudinal axis;
first and second tapered portions respectively connected at diametrically larger ends thereof to axially opposed ends of said enlarged round center portion;
first and second pipe portions respectively connected to diametrically smaller ends of said first and second tapered portions respectively; and
accordion folds defined by and between said first tapered portion and said first pipe portion;
wherein said first pipe portion is bent relative to said longitudinal axis as a result of plastic deformation of said accordion folds.

2. A metal case of an exhaust device, comprising:
an enlarged round center portion having a longitudinal axis;
first and second tapered portions respectively connected at diametrically larger ends thereof to axially opposed ends of said enlarged round center portion;
first and second pipe portions respectively connected to diametrically smaller ends of said first and second tapered portions respectively;
first accordion folds defined by and between said first tapered portion and said first pipe portion; and
second accordion folds defined by and between said second tapered portion and said second pipe portion,
wherein at least one of said first and second pipe portions is bent relative to said longitudinal axis as a result of plastic deformation of corresponding one of said first and second accordion folds.

3. A metal case as claimed in claim 2, in which said enlarged round center portion, said first and second tapered portions, said first and second pipe portions are integrally connected to one another to provide a monolithic structure.

4. A metal case as claimed in claim 2, in which at least one of said first and second accordion folds comprises:
first group of accordion folds;
second group of accordion folds; and
a mating round portion through which said first and second groups of accordion folds are connected,
wherein plastic deformation degree of said first group of accordion folds is different from that of said second group of accordion folds.

5. A metal case as claimed in claim 4, in which said first group of accordion folds is defined by said first inlet pipe portion and said second group of accordion folds is defined by said first tapered portion.

6. A metal case as claimed in claim 3, in which said monolithic structure is made of stainless steel plate or copper plate.

7. A method of producing a metal case of an exhaust device, comprising the steps of:
(a) preparing a round hollow body of metal;
(b) subjecting said round hollow body to a drawing process to provide a first semi-finished aligned product which comprises an enlarged round center portion, first and second tapered portions respectively connected at diametrically larger ends thereof to axially opposed ends of said enlarged round center portion, and first and second pipe portions respectively connected to diametrically smaller ends of said first and second tapered portions respectively;
(c) subjecting said first semi-finished aligned product to a folds-producing process to produce and define accordion folds between said first tapered portion and said first pipe portion thereby to provide a second semi-finished aligned product;
(d) holding a major portion of said second semi-finished aligned product to a fixed member; and
(e) applying a given force to said first and second pipe portion in a manner to induce a plastic deformation of said accordion folds thereby to bend the pipe portion relative to a longitudinal axis of said major portion of said second semi-finished aligned product.

8. A method of producing a metal case of an exhaust device, comprising the steps of:
(a) preparing a round hollow body of metal;
(b) subjecting said round hollow body to a drawing process to provide a first semi-finished aligned product which comprises an enlarged round center portion, first and second tapered portions respectively connected at diametrically larger ends thereof to axially opposed ends of said enlarged round center portion, and first and second pipe portions respectively connected to diametrically smaller ends of said first and second tapered portions respectively;
(c) subjecting said first semi-finished aligned product to a folds-producing process to produce and define first accordion folds between said first tapered portion and said first pipe portion and second accordion folds between said second tapered portion and said second pipe portion thereby to provide a second semi-finished aligned product;
(d) holding a major portion of said second semi-finished aligned product to a fixed member; and
(e) applying a given force to at least one of said first and second pipe portions in a manner to induce a plastic deformation of corresponding one of said first and second accordion folds thereby to bend the pipe portion relative to a longitudinal axis of said major portion of said second semi-finished aligned product.

9. A method as claimed in claim 8, in which the step (e) comprises:
(f) holding said pipe portion by a clamp;
(g) inserting a round bar into said pipe portion; and
(h) pulling both said clamp and said round bar in a given direction with the given force.

10. A method as claimed in claim 8, in which the step (d) comprises:
(i) holding said first and second tapered portions by respective clamps.

11. A method as claimed in claim 8, in which the step (d) comprises:
(j) holding said enlarged round center portion by a clamp.

12. A catalytic converter comprising:
a metal case including an enlarged round center portion having a longitudinal axis, first and second tapered portions respectively connected at diametrically larger ends thereof to axially opposed ends of said enlarged round center portion, first and second pipe portions respectively connected to diametrically smaller ends of said first and second tapered portions respectively, first accordion folds defined by and between said first tapered portion and said first pipe portion, and second accordion folds defined by and between said second tapered portion and said second pipe portion, at least one of said first and second pipe portions being bent relative to said longitudinal axis as a result of plastic deformation of corresponding one of said first and second accordion folds; and
a catalyst carrier tightly installed in said enlarged round center portion of said metal case.

13. A method of producing a catalytic converter, comprising the steps of:
(a) preparing a round hollow body of metal;
(b) inserting a catalyst carrier into said round hollow body;
(c) subjecting said round hollow body to a drawing process to provide a first semi-finished aligned product which comprises an enlarged round center portion in which said catalyst carrier is installed, first and second tapered portions respectively connected at diametrically larger ends thereof to axially opposed ends of said enlarged round center portion, and first and second pipe portions respectively connected to diametrically smaller ends of said first and second tapered portions respectively;
(d) subjecting said first semi-finished aligned product to a folds-producing process to produce and define first accordion folds between said first tapered portion and said first pipe portion and second accordion folds between said second tapered portion and said second pipe portion thereby to provide a second semi-finished aligned product;
(e) holding a major portion of said second semi-finished aligned product to a fixed member; and
(f) applying a given force to at least one of said first and second pipe portions in a manner to induce a plastic deformation of corresponding one of said first and second accordion folds thereby to bend the pipe portion relative to a longitudinal axis of said major portion of said second semi-finished aligned product.
